(19) United States
(12) Patent Application Publication
(10) Pub. No.: US 2025/0240126 A1
(43) Pub. Date: Jul. 24, 2025

(54) CODE BLOCK GROUP BASED OUTER LOOP LINK ADAPTATION FOR EXTENDED REALITY

(71) Applicant: Nokia Technologies Oy, Espoo (FI)

(72) Inventors: Klaus Ingemann PEDERSEN, Aalborg (DK); Troels Emil KOLDING, Aalborg (DK); Pouria PAYMARD, Aalborg (DK)

(21) Appl. No.: 18/839,780

(22) PCT Filed: Mar. 20, 2023
(86) PCT No.: PCT/EP2023/057000

§ 371 Date: Aug. 20, 2024

Related U.S. Application Data
(60) Provisional application No. 63/325,081, filed on Mar. 29, 2022.

(51) Int. Cl. H04L 1/20; H04L 1/00

(52) U.S. Cl. CPC H04L 1/203; H04L 1/0061

(57) ABSTRACT

Systems, methods, apparatuses, and computer program products for code block group based outer loop link adaptation for extended reality. For example, a method may include initializing parameters of an outer loop link adaptation of a user equipment. The method may also include controlling, with the outer loop link adaptation, at least one of a first transmission block 10 error rate, a second transmission residual block error rate, or a probability of having at most N failed code block groups in the first transmission.

### CROSS REFERENCE TO RELATED APPLICATION

This application claims the benefit of U.S. Provisional Application No. 63/325,081, filed Mar. 29, 2022, which is hereby incorporated by reference in its entirety.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for code block group based outer loop link adaptation for extended reality.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory comprising computer program code. The at least one memory and computer program code can be configured, with the at least one processor, to cause the apparatus at least to initialize parameters of an outer loop link adaptation of a user equipment. The at least one memory and computer program code can also be configured, with the at least one processor, to cause the apparatus at least to control, with the outer loop link adaptation, at least one of a first transmission block error rate, a second transmission residual block error rate, or a probability of having at most N failed code block groups in the first transmission.

An embodiment may be directed to a method. The method may include initializing parameters of an outer loop link adaptation of a user equipment. The method may also include controlling, with the outer loop link adaptation, at least one of a first transmission block error rate, a second transmission residual block error rate, or a probability of having at most N failed code block groups in the first transmission.

An embodiment may be directed to an apparatus. The apparatus may include means for initializing parameters of an outer loop link adaptation of a user equipment. The apparatus may also include means for controlling, with the outer loop link adaptation, at least one of a first transmission block error rate, a second transmission residual block error rate, or a probability of having at most N failed code block groups in the first transmission.

### BRIEF DESCRIPTION OF THE DRAWINGS

For proper understanding of example embodiments, reference should be made to the accompanying drawings, wherein:

FIG. 1 illustrates a method including three options for control, according to certain embodiments;

FIG. 2 illustrates behavior of a first option according to certain embodiments;

FIG. 3 illustrates behavior of a second option according to certain embodiments; and

FIG. 4 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for code block group based outer loop link adaptation for extended reality, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments relate to improved link adaptation (LA) for extended reality (XR) use cases, for example where code block group (CBG) based Hybrid Automatic Repeat request (HARQ) can be applied. Certain embodiments particularly address the so-called outer loop LA (OLLA) that is set to control the block error operation point that may be desirable to achieve resource-efficient transmissions, subject to potential latency and/or HARQ retransmission constraints.

OLLA can be designed for basic cases with legacy hybrid automatic repeat request (HARQ) operation with Boolean acknowledgment/negative acknowledgment (ACK/NACK) feedback, and retransmissions of the full 5 transport block size (TBS) in case of failures. Such an OLLA scheme can take action based on this Boolean HARQ feedback from the first HARQ transmissions only with the aim of controlling the first transmission block error rate (BLER).

Certain embodiments may provide more efficient enhanced OLLA (eOLLA) schemes, which may be suitable for cases with large TBS, as may be suitable for XR cases, and CBG-based HARQ operation with multi-bit feedback that expresses which CBGs that might be erroneous.

Certain embodiments can provide an eOLLA scheme that offers improved spectral efficiency over previous OLLA schemes. The eOLLA scheme can be optimized for XR or similar use cases where the TBS of first transmissions is typically very large. Examples of such cases may include augmented reality (AR)/virtual reality (VR) use cases with 4K/8K video quality at 45 Mbps and 60 frames per second (fps) on average. Cases with such large TBS transmissions may suitable for using CBG-based HARQ. In case of failure, the system may only need to retransmit the erroneous CBGs, as compared to retransmitting the full TB. The CBG-based HARQ can come with multi-bit feedback to identify the CBGs that may have been erroneously decoded, as compared to traditional HARQ in which a single bit Boolean ACK/NACK feedback is provided.

Accordingly, certain embodiments provide an eOLLA scheme that (i) may utilize the richer multi-bit HARQ feedback to reach faster convergence and (ii) may control the LA performance so it is taken explicitly into account that failures to successfully decode a TB do not necessarily result in a retransmission of the full TB. Certain embodiments may offer enhanced LA performance for XR use cases with CBG-based HARQ, resulting in more resource-efficient solutions, working together with the currently defined channel quality indicator (CQI) feedback schemes for the UEs. Secondly, certain embodiments may offer the possibility to decide whether the eOLLA controls the first transmission BLER target, the second transmission residual BLER target, or the probability of having at most K failed CBGs in a first transmission.

OLLA was originally developed for high-speed downlink packet access (HSDPA) to handle dynamic link adaptation for a user to operate at a target BLER for a first transmission. A basic OLLA principle can be as follows: if an ACK is received for a first transmission, the OLLA_offset can be decreased by OLLA_Offset_Down; if a NACK is received for a first transmission, the OLLA_offset can be increased by OLLA_Offset_Up; and the ratio between the OLLA_Offset_Up and OLLA_Offset_Down can determine the first transmission BLER target. A typical configuration may be OLLA_Offset_Up=0.5 dB and OLLA_Offset_Down=0.05 dB to achieve a BLER target of 10%. The OLLA_offset can be subtracted from the received CQI information from the UE, and based on that the next generation Node B (gNB) can select a corresponding modulation and coding scheme (MCS). Independent OLLA algorithms can run in the gNB for each UE, as the OLLA can also help compensate for potential UE measurement imperfections for CQI feedback. An OLLA offset can modify a signal to noise ratio (SNR) threshold. A positive value may make an MCS selection more robust, while a negative value may be used when it is determined that a CQI selection was too strict.

Such OLLA may take hundreds to thousands of first transmissions to fully converge. Furthermore, OLLA without certain embodiments may not be designed for cases with CBG-based HARQ and multi-bit feedback.

In addition to controlling the BLER target for LA by using OLLA schemes, fifth generation (5G) new radio (NR) can also include various options for CQI feedback. In release 15 (Rel-15), LTE-like CQI schemes were standardized corresponding to a BLER target of 0.1 (10%), including options for wideband and frequency selective CQI. In Rel-16, additional CQI tables were standardized for other BLER targets such as 10-5 as may be required for some internet of things (IoT) use cases. In Rel-17, further CQI enhancements may be included to enable 4-bit sub-band CQI feedback.

CBG-based HARQ is one aspect of 5G NR. For example, CBG-based transmission is specified in 3GPP TS 38.214, in section 5.1.7 entitled “Code block group based physical downlink shared channel (PDSCH) transmission.” Details of HARQ feedback for CBG based transmissions are, for example, specified in 3GPP TS 38.213, section 9.1.1 “CBG-based HARQ-ACK codebook determination.” Aspects of CBG-based transmissions also appear in, for example, the medium access control (MAC) specification, 3GPP TS 38.321. In these approaches, generally speaking, the transport block (TB) may be organized into multiple code blocks (CBs). The maximum size of a CB may be, for example, 8448 bits. The CBs can be grouped into CBGs. For each received TB, the receiver can provide feedback to indicate which CBGs are in error, and only the erroneously received CBGs are thereafter retransmitted by the transmitter. For transmission of large TB for XR use cases as defined in 3GPP TR 38.838, cases with 8 CBGs per TB may be supported. More generally, the maximum number of CBGs per TB may be configurable as N∈{2, 4, 6, 8} for the PDSCH.

One method for improving the XR performance could be to use enhanced CBG-based HARQ operation and smart link adaption.

Certain embodiments may have various options where the richer multi-bit feedback from the CBG-based HARQ can be utilized for adjusting the OLLA_offset. The various options may be designated as option #1, option #2, and option #3, for convenience only and not by way of limitation, preference, or priority.

For convenience, therefore, option #1 can refer to using eOLLA for controlling the first transmission BLER for any transmitted CBG; option #2 can refer to using eOLLA for controlling the residual BLER of the second transmission for any transmitted CBG, for example corresponding to the first HARQ retransmission; and option #3 can refer to using eOLLA for controlling the probability of having at most K failed CBGs in the first transmission.

Option #1 may reflect an enhancement to prior OLLA schemes to conduct adjustments based on multi-bit HARQ feedback to offer fast convergence. Option #2 may not explicitly control first transmissions for a certain BLER target. Instead, Option #2 may control the residual BLER target of the second transmission, for example the first HARQ retransmission. Option #2 may be useful for cases where one HARQ retransmission is allowed, given the latency budget, and CBG-based operation allows for more statistical events to control this aspect. This option may be of interest for XR services, where it may be valuable to control the residual BLER, for example keeping residual BLER at 1%, while of less importance to control the first transmission to equal a specific BLER target. Option #1 and option #2 may be used in combination. Option #3 may offer the possibility to have the eOLLA control the probability of having most K failed CBGs in the first transmission. For XR cases with large TBSs that often contain 8 CBGs, the eOLLA of option #3 could therefore be used to, for example, aim at having 30% probability of having at most K=4 failed CBGs for first transmissions.

Thus, certain embodiments may provide methods for the eOLLA to control either the first transmission BLER, the second transmission residual BLER, or the probability of having most N failed CBGs in the first transmission. This is achieved by having the eOLLA perform smart adjustments of OLLA_offset based on the richer CBG-based HARQ multi-bit feedback.

Certain embodiments may have various benefits and/or advantages. For example, certain embodiments may help unleash the full benefits of using CBG-based HARQ through smarter link adaptation. The benefits and advantages of the eOLLA may include faster convergence and more resource-efficient transmissions that translate to higher system capacity. This is especially the case for XR use cases with large TBS that often contain many CBGs. The proposed options of the eOLLA also offer flexibility for controlling either the first transmission BLER, the second transmission residual BLER, or the probability of having at most K CBGs in error for first transmissions. This flexibility is desirable so networks can select the option that is most suitable given the QoS constraints for the service of the user.

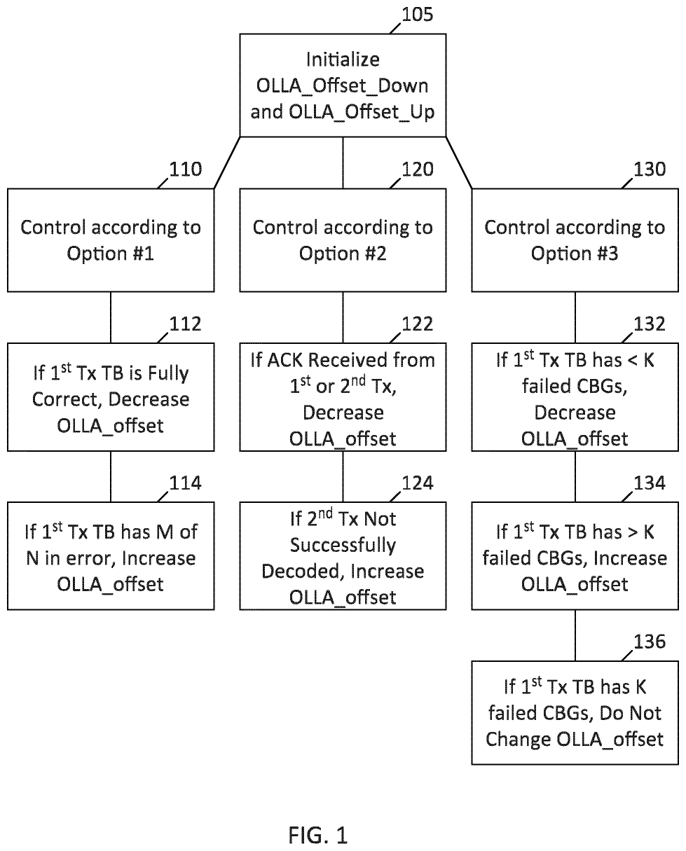

FIG. 1 illustrates three options for control, according to certain embodiments. Options #1, #2, and #3 are further described in the following implementation examples, which are merely examples for the purpose of illustration. Finally, also notice that although eOLLA is described for XR use cases, it is not restricted to such use cases. The eOLLA described could also be used for other high-data rate use cases with large payload CBG-based transmissions. No matter what approach is used, the values of increments, OLLA_Offset_Down and OLLA_Offset_Up can be initialized at 105. Other values can also be initialized at this time including, for example, an initial value of OLLA_offset.

As mentioned above, in option #1, the eOLLA can be used for controlling the first transmission BLER. Control 110 according to option #1 can include, at 112, if a first transmission TB is received fully correct, the eOLLA can decrease the OLLA_offset by OLLA_Offset_Down decibels. By contrast, at 114, if a first transmission TB that has N CBGs also has M (M>0) of those N in error, the OLLA_offset can be increased by OLLA_Offset_Up×M/N. OLLA_Offset_Up and OLLA_Offset_Down can be semi-static network parameters. With this approach, the first transmission BLER may converge to equal 1/(OLLA_Offset_Up/OLLA_Offset_Down+1). Thus, by setting OLLA_Offset_Down and OLLA_Offset_Up, the BLER can be controllable.

The process at 114 can take advantage of the CBG-based HARQ multi-feedback so the increase of the OLLA_Offset can be scaled by the ratio of failed CBGs in the TB. This scaling can take the cost of the subsequent retransmission into account, where only the failed CBGs are retransmitted.

This option may allow more accurate control and may also offer faster convergence of the eOLLA as compared to approaches that always perform large increases of the OLLA_offset independent of whether the TB is subject to few or many failed CBGs.

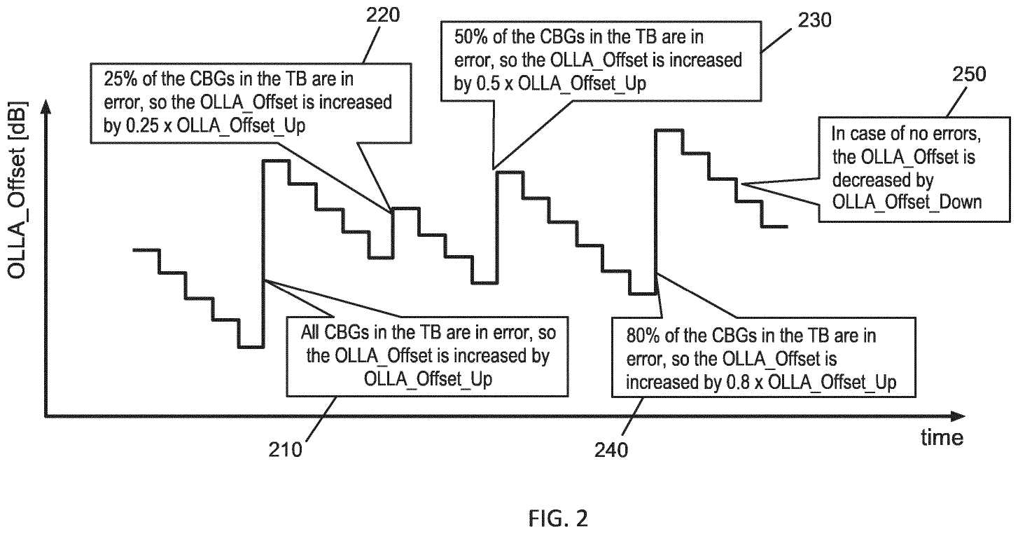

FIG. 2 illustrates behavior of a first option according to certain embodiments. As shown in FIG. 2, the behavior of the eOLLA is illustrated with respect to how the OLLA_Offset is adjusted over time depending on the CBG-based HARQ multi-bit feedback from first transmissions. As can be seen, the increase of the OLLA_Offset when there are errors in the TB reception can vary depending on the relative ratio of failed CBGs. This is in contrast to an approach where the OLLA_Offset is increased by a fixed (and relatively large) step size whenever part of a TB is in error.

Another option may be to adjust the OLLA_offset based on the sum of received ACK/NACKs from the different CBGs as follows: OLLA_offset=SUM(M)*OLLA_Offset_Down+SUM(N−M)*Olla_Offset_Up. However, such a solution would result in potential large adjustments of the OLLA_offset after each transmission, which could lead to instability. Also, such a summing approach may not offer the desired control point as per option #1.

As mentioned above, in option #2, the eOLLA can be used for controlling the residual BLER of the second transmission, which may correspond to the first HARQ retransmission. Certain embodiments of the eOLLA can, at 120 in FIG. 1, control the residual BLER of the second transmission. This control may be of relevance to XR services, where control of the residual BLER may be valuable, for example there may be value in keeping residual BLER at 1%, while it may be of less importance to accurately control the first transmission to equal a specific BLER target. The approach of option #2 may be realized by monitoring HARQ multi-bit feedback from both first and second HARQ transmissions, for example corresponding to the first retransmission.

At 122, if ACK is received from a first or second transmission, then OLLA_Offset can be decreased by OLLA_Offset_Down. At 124, if a second transmission is not successfully decoded, then OLLA_Offset can be increased by OLLA_Offset_Up×M/N, where N is the number CBGs in the second transmission and M is the number of erroneous CBGs in the second transmission. As in option #1, OLLA_Offset_Up and OLLA_Offset_Down can be semi-static network parameters. With the approach of option #2, the residual BLER after the second transmission, for example the first HARQ retransmission, can converge to equal 1/(OLLA_Offset_Up/[2×OLLA_Offset_Down]+1). By setting OLLA_Offset_Down and OLLA_Offset_Up, the residual second transmission BLER is controllable.

As shown in FIG. 2, at 210 all CBGs in the TB may be in error so the OLLA_Offset may be increased by OLLA_Offset_Up. At 220, 25% of the CBGs in the TB may be in error, so the OLLA_Offset may be increased by 0.25×OLLA_Offset_Up. At 230, 50% of the CBGs in the TB may be in error, so the OLLA_Offset is increased by 0.5×OLLA_Offset_Up. At 240, 80% of the CBGs in the TB may be in error, so the OLLA_Offset may be increased by 0.8×OLLA_Offset_Up. At 250, in case of no errors, the OLLA_Offset may be decreased by OLLA_Offset_Down.

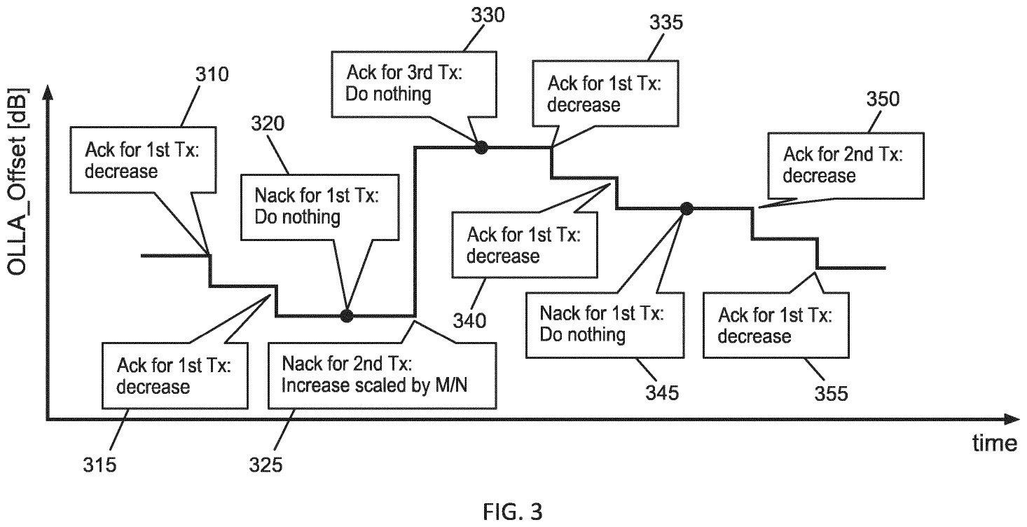

FIG. 3 illustrates behavior of a second option according to certain embodiments. For example, for option #2, the OLLA_Offset may only be modified if a second transmission is not fully correctly decoded, while no actions may be taken if a first transmission is in error. This may be a consequence of only explicitly controlling the residual BLER after the second transmission. When errors are detected for second transmissions, the increase of the OLLA_Offset can be weighted by the relative ratio of CBGs that are in error for the second transmission, for example accounting for the cost of the subsequent retransmission of those failed CBGs. The OLLA_Offset may be decreased based on both HARQ ACK from the first and second HARQ transmissions.

The approach of option #2 may further be extended by still monitoring the BLER of the first transmissions and, for example, controlling that the first transmission BLER does not exceed a certain parameterized upper bound value. This extension could be implemented by, for example using a moving average window to estimate the first transmission BLER, and force the OLLA_offset to be increased if the upper bound value of the first transmission BLER is reached. The extension may also be realized by combining Options #1 and #2.

As mentioned above, in option #3, the eOLLA can be used for, at 130 in FIG. 1, controlling the probability of having at most K failed CBGs in the first transmissions. This approach may offer the possibility to have the eOLLA control the probability of having most N failed CBGs in the first transmission. For XR cases with large TBSs that often contain 8 CBGs, this option could therefore be used to, for example, aim at having 30% probability of having at most K=4 failed CBGs for first transmissions (example, this is parametrized).

Option #3 can include, at 132, if a first transmission TB has less than K failed CBGs, decrease the OLLA_offset by OLLA_Offset_Down decibels. The method can further include, at 134, if a first transmission TB has more than K failed CBGs, increase the OLLA_Offset by OLLA_Offset_Up. If a first transmission TB has exactly K failed CBGs, at 146 the OLLA_offset may not be changed. As in option #1 and option #2, OLLA_Offset_Up and OLLA_Offset_Down can be semi-static network parameters.

With the approach of option #3, the error rate for having at most N failed CBGs in first transmissions may converge to equal 1/(OLLA_Offset_Up/OLLA_Offset_Down+1). So, by setting OLLA_Offset_Down and OLLA_Offset_Up, the error probability of having at most K failed CBGs in first transmissions may be controllable.

The value of K may either be a fixed integer parameter, or it could be a parameter that is dynamically calculated so it corresponds to a certain percentage of allowed failed CBGs. Thus, the approach of option #3 may also work under conditions where the transmitted TBs may contain varying number of CBGs.

Option #1, option #2, and option #3 can be implemented in the gNB to have a good eOLLA for dynamic scheduled downlink and uplink transmissions. An implementation may include bounded conditions, where the eOLLA may only be allowed to adjust the OLLA_Offset within the range from OLLA Min to OLLA Max, where those two parameters express the minimum and maximum allowed values for the OLLO_offset. In a more advanced setting where the UE is allowed to autonomously adjust its modulation and coding scheme (MCS) of uplink transmissions, as could, for example, be the case for enhanced configured grant transmissions, the eOLLA may be implemented in the UE. For such cases, parameters such as OLLA_Offset_Up, OLLA_Offset_Down, K, and which option to use may be signaled to the UE from the gNB, for example, via radio resource control (RRC) signaling. The UE may then adjust the UE's own MCS in accordance with the OLLA_Offset.

As shown in FIG. 3, at 310 there can be an ACK for a first transmission, leading to a decrease in OLLA_Offset. At 315, the same may occur. At 320, there may be a NACK for a first transmission, and no action may be taken. When a NACK is received for a second transmission at 325, there can be an increase in OLLA_Offset, which can be scaled by M/N. When an ACK is received for a third transmission, at 330 nothing may be done with respect to OLLA_Offset. At 335, there may be an ACK for a first transmission, leading to a decrease. The same may occur at 340. At 350, there may be a NACK for a first transmission, and no action may be taken. Then, there may be an ACK for a second transmission, leading to a decrease at 350, and again the same at 335.

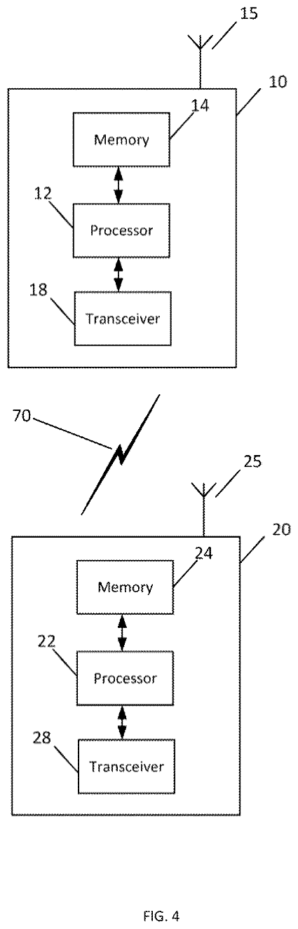

FIG. 4 illustrates an example of a system that includes an apparatus 10, according to an embodiment. In an embodiment, apparatus 10 may be a node, host, or server in a communications network or serving such a network. For example, apparatus 10 may be any device in a network, such as a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 4.

As illustrated in the example of FIG. 4, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 4, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-3, or any other method described herein. In some embodiments, as discussed herein, apparatus 10 may be configured to perform a procedure relating to code block group based outer loop link adaptation for extended reality, for example.

FIG. 4 further illustrates an example of an apparatus 20, according to an embodiment. In an embodiment, apparatus 20 may be or may represent any node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 4.

As illustrated in the example of FIG. 4, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, the apparatus 20 may be or may be a part of a UE, SL UE, relay UE, mobile device, mobile station, ME, IoT device and/or NB-IoT device, or the like, for example.

According to certain embodiments, apparatus 20 may be controlled by memory 24 and processor 22 to perform the functions associated with any of the embodiments described herein, such as one or more of the operations illustrated in, or described with respect to, FIGS. 1-3, or any other method described herein. For example, in an embodiment, apparatus 20 may be controlled to perform a process relating to code block group based outer loop link adaptation for extended reality, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments may help unleash the full benefits of using CBG-based HARQ through smarter link adaptation. The benefits and advantages of the eOLLA may include faster convergence and more resource-efficient transmissions that translate to higher system capacity. This is especially the case for XR use cases with large TBS that often contain many CBGs. The proposed options of the eOLLA also offer flexibility for controlling either the first transmission BLER, the second transmission residual BLER, or the probability of having at most K CBGs in error for first transmissions. This flexibility is desirable so networks can select the option that is most suitable given the QoS constraints for the service of the user.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### Partial Glossary

ACK Acknowledgement
ARQ Automatic repeat request
BLER Block error rate
CB Code block
CBG Code block group
DL Downlink
eOLLA enhanced OLLA
HARQ Hybrid ARQ
IE Information Element
LA Link adaptation
MAC Medium access control
MCS Modulation and coding scheme
NACK Negative ACK
OFDM Orthogonal frequency domain multiplexing
OLLA Outer loop link adaptation
PDSCH Physical downlink shared channel
RE Resource element
RRC Radio resource control
SCS Subcarrier spacing
TB Transport block
TBS TB size
UE User equipment
UL Uplink
QoS Quality of service

1. An apparatus, comprising:
at least one processor; and
at least one memory including computer program code,
wherein the at least one memory and the computer program code are configured to, with the at least one processor, cause the apparatus at least to
initialize parameters of an outer loop link adaptation of a user equipment; and
control, with the outer loop link adaptation, at least one of a first transmission block error rate, a second transmission residual block error rate, or a probability of having at most N failed code block groups in the first transmission.

2. The apparatus of claim 1, wherein the parameters comprise an outer loop link adaptation offset up value and an outer loop link adaptation offset down value.

3. The apparatus of claim 2, wherein the at least one memory and the computer program code are configured to, with the at least one processor, cause the apparatus at least to,
when a first transmission transport block is received fully correct, decrease an outer loop link adaptation offset by the outer loop link adaptation offset down value;
when a first transmission transport block is received with errors for M of N total code block groups, increase an outer loop link adaptation offset by the outer loop link adaptation offset up value times M/N.

4. (canceled)

5. The apparatus of claim 2, wherein the at least one memory and the computer program code are configured to, with the at least one processor, cause the apparatus at least to control the first transmission block error rate to converge to 1/(outer loop link adaptation offset up value/outer loop link adaptation offset down value+1).

6. The apparatus of claim 2, wherein the at least one memory and the computer program code are configured to, with the at least one processor, cause the apparatus at least to, when acknowledgement is received from a first transmission and a second transmission, decrease an outer loop link adaptation offset by the outer loop link adaptation offset down value.

7. The apparatus of claim 2, wherein the at least one memory and the computer program code are configured to, with the at least one processor, cause the apparatus at least to, when a second transmission is not successfully decoded, increase an outer loop link adaptation offset by the outer loop link adaptation offset up value times M/N, where N is a number of code block groups in the second transmission and M is a number of erroneous code block groups in the second transmission.

8. The apparatus of claim 2, wherein the wherein the at least one memory and the computer program code are configured to, with the at least one processor, cause the apparatus at least to control the residual block error rate to converge to 1/(outer loop link adaptation offset up value/(2×outer loop link adaptation offset down value)+1).

9. The apparatus of claim 2, wherein the wherein the at least one memory and the computer program code are configured to, with the at least one processor, cause the apparatus at least to control the residual block error rate to prevent the residual block error rate from exceeding a parameterized upper bound value using a moving average window to estimate a first transmission block error rate and force an outer loop link adaptation offset to increase if the parameterized upper bound value is reached.

10. The apparatus of claim 2, wherein the parameters further comprise a threshold of failed code block groups.

11. The apparatus of claim 10, wherein the at least one memory and the computer program code are configured to, with the at least one processor, cause the apparatus at least to, when a first transmission transport block has fewer than the threshold of failed code block groups, decrease an outer loop link adaptation offset by the outer loop link adaptation offset down value.

12. The apparatus of claim 10, wherein the at least one memory and the computer program code are configured to, with the at least one processor, cause the apparatus at least to, when a first transmission transport block has more than the threshold of failed code block groups, increase an outer loop link adaptation offset by the outer loop link adaptation offset up value.

13. The apparatus of claim 10, wherein the at least one memory and the computer program code are configured to, with the at least one processor, cause the apparatus at least to, when a first transmission transport block has exactly the threshold of failed code block groups, maintain a current value of an outer loop link adaptation offset.

14. The apparatus of claim 10, wherein the at least one memory and the computer program code are configured to, with the at least one processor, cause the apparatus at least to, control an error rate for having at most a predetermined number of failed code block groups in first transmissions to converge to 1/(outer loop link adaptation offset up value/outer loop link adaptation offset down value+1).

15. The apparatus of claim 10, wherein the predetermined threshold comprises a fixed integer parameter or a dynamically calculated parameter corresponding to a predetermined percentage of allowed failed code block groups.

16. The apparatus of claim 2, wherein the outer loop link adaptation offset up value and the outer loop link adaptation offset down value are semi-static network parameters.

17. The apparatus of claim 1, wherein the outer loop link adaptation is configured to allow adjustment of an outer loop link adaptation offset within a predetermined range of values.

18. A method, comprising:
initializing parameters of an outer loop link adaptation of a user equipment; and
controlling, with the outer loop link adaptation, at least one of a first transmission block error rate, a second transmission residual block error rate, or a probability of having at most N failed code block groups in the first transmission.

19. The method of claim 18, wherein the parameters comprise an outer loop link adaptation offset up value and an outer loop link adaptation offset down value.

20. The method of claim 19, further comprising:
when a first transmission transport block is received fully correct, decreasing an outer loop link adaptation offset by the outer loop link adaptation offset down value; and
when a first transmission transport block is received with errors for M of N total code block groups, increase an outer loop link adaptation offset by the outer loop link adaptation offset up value times M/N.

21. (canceled)

22. The method of claim 19, further comprising:
controlling the first transmission block error rate to converge to 1/(outer loop link adaptation offset up value/outer loop link adaptation offset down value+1).

23-53. (canceled)
